(19) United States
(12) Patent Application Publication
(10) Pub. No.: US 2023/0014483 A1
(43) Pub. Date: Jan. 19, 2023

(54) ELECTRODE FOR LITHIUM-ION BATTERY AND LITHIUM-ION BATTERY COMPRISING THE SAME

(71) Applicant: NATIONAL YANG MING CHIAO TUNG UNIVERSITY, Hsinchu City (TW)

(72) Inventors: Chih CHEN, Hsinchu City (TW); Fu-Chian CHEN, Hsinchu City (TW); Wei-You HSU, Hsinchu City (TW); Wen-Wei WU, Hsinchu City (TW); Jeng-Kuei CHANG, Hsinchu City (TW)

(21) Appl. No.: 17/469,352

(22) Filed: Sep. 8, 2021

(30) Foreign Application Priority Data
Jul. 8, 2021 (TW) 110125103

(51) Int. Cl. H01M 4/66; H01M 4/587; H01M 4/38; H01M 10/0525

(52) U.S. Cl. CPC H01M 4/661; H01M 4/587; H01M 4/386; H01M 10/0525; H01M 2004/027

(57) ABSTRACT

An electrode for a lithium-ion battery is disclosed, which comprises: a collector comprising a nano-twinned copper foil; and a negative electrode material disposed on the collector, wherein the negative electrode material comprises at least one selected from the group consisting of: silicon, silicon nitride, graphite, graphene, carbon nanotubes, carbon nano-fibers and carbon nano-particles. In addition, a lithium-ion battery comprising the aforesaid electrode is also provided.

### CROSS REFERENCE TO RELATED APPLICATION

This application claims the benefits of the Taiwan Patent Application Serial Number 110125103, filed on Jul. 8, 2021, the subject matter of which is incorporated herein by reference.

### BACKGROUND

### 1. Field

The present disclosure relates to an electrode for a lithium-ion battery and a lithium-ion battery comprising the same. More specifically, the present disclosure relates to an electrode for a lithium-ion battery which can improve the energy density of the lithium-ion battery and a lithium-ion battery comprising the same.

### 2. Description of Related Art

Lithium-ion batteries are one of the well-known lithium batteries because of their high power storage capacity. They have a wide range of applications. For example, they can be used in electric vehicles, electronics, and medical equipment. Common lithium batteries use the rolled copper foil as the collector for the negative electrode and less use the electroplated copper foil as the collector for the negative electrode. It is because that the strength of the electroplated copper foil is generally lower than that of the rolled copper foil, and the cost of the thicker electroplated copper foil is also higher than the cost of the rolled copper foil.

In recent years, due to the rise of electric vehicles and smart phones, the demand for high-energy-density lithium batteries has increased significantly. In order to increase the energy density of lithium batteries, the thickness of the copper foil used as the collector of the negative electrode is also required to be thinner As the thickness of the copper foil decreased to 5 μm, the cost of the rolled copper foil is much higher than the cost of the electroplated copper foil, which is not suitable for the commercial applications.

Therefore, it is desirable to provide a collector for the negative electrode, which has the advantages of high strength, good electrical properties, or low cost, so as to be applied to lithium batteries with high energy density.

### SUMMARY

The present disclosure is related to an electrode for a lithium-ion battery to effectively improve the energy density of the lithium-ion battery. In addition, the present disclosure is further related to a lithium-ion battery using the electrode of the present disclosure.

The electrode for the lithium-ion battery of the present disclosure comprises: a collector comprising a nano-twinned copper foil; and a negative electrode material disposed on the collector, wherein the negative electrode material comprises at least one selected from the group consisting of: silicon, silicon nitride, graphite, graphene, carbon nanotubes, carbon nano-fibers and carbon nano-particles.

In the present disclosure, the collector comprising the nano-twinned copper foil is used in the negative electrode of the lithium-ion battery to improve the energy density of the lithium-ion battery. In particular, the nano-twinned copper foil has the advantage of high strength, high conductivity and high thermal stability. Compared to the commercial rolled copper foil, the nano-twinned copper foil not only have the high conductivity as the commercial rolled copper foil has, but also can further be resistant to the volume change of the negative material during charging and discharging. Therefore, the stability and reliability of the electrode can be improved, and the energy density of the lithium-ion battery can further be effectively increased.

In the present disclosure, the negative electrode material may comprise an active material which comprises at least one selected from the group consisting of: silicon, silicon nitride, graphite, graphene, carbon nanotubes, carbon nano-fibers and carbon nano-particles. In one embodiment of the present disclosure, the active material in the negative electrode material may be a silicon-based material including silicon, silicon nitride, or a combination thereof In another embodiment of the present disclosure, the active material in the negative electrode material may comprise silicon and silicon nitride. It is known that the silicon-based active material has high charge/recharge characteristics. However, the huge volume change of the silicon-based active material during charging and recharging leads the cracking of the silicon-based active material. Thus, the charge/recharge characteristics of the lithium-ion battery may be deteriorated or the energy density of the lithium-ion battery may be decreased, resulting in the life time of the lithium-ion battery shortened. In the present disclosure, when the nano-twinned copper foil is used as the collector, the nano-twinned copper foil can resist the volume change of the silicon-based material during charging and discharging, and thus the aforesaid problems of the deterioration of the charge/recharge characteristics or the decreasing of the energy density of the lithium-ion battery can be solved. In addition, the negative electrode material may further selectively comprise an adhesive material. The adhesive material can mix with the active material to form slurry of the negative electrode material, and then the negative electrode material is applied onto the collector to form the electrode for the lithium-ion battery of the present disclosure.

In the present disclosure, when the active material comprises silicon and silicon nitride, based on a total weight of the silicon and the silicon nitride, a content of the silicon nitride may be ranged from 25% to 85%, 25% to 80%, 25% to 75%, 30% to 75%, 30% to 70%, 35% to 70%, 35% to 65%, 40% to 65% or 40% to 60%. In one embodiment of the present disclosure, the content of the silicon nitride may be about 50%.

In the present disclosure, the thickness of the nano-twinned copper foil may be adjusted according to the need. In one embodiment of the present disclosure, the thickness of the nano-twinned copper foil may be ranged from, for example, 1 μm to 500 μm, 1 μm to 400 μm, 1 μm to 300 μm, 1 μm to 200 μm, 1 μm to 100 μm, 1 μm to 80 μm, 1 μm to 50 μm, 2 μm to 50 μm, 3 μm to 50 μm, 3 μm to 40 μm, 3 μm to 35 μm, 4 μm to 35 μm, 4 μm to 30 μm, 4 μm to 25 μm, 4 μm to 20 μm, 4 μm to 15 μm or 4 μm to 10 μm; but the present disclosure is not limited thereto.

In the present disclosure, at least 50% in volume of the nano-twinned copper foil may comprise plural twinned grains. In one embodiment of the present disclosure, for example, 50% to 99%, 50% to 95%, 50% to 90%, 55% to 90%, 60% to 90% or 60% to 85% in volume of the nano-twinned copper foil may comprise plural twinned grains; but the present disclosure is not limited thereto.

In the present disclosure, the diameters of the plural twinned grains may be respectively ranged from 0.1 μm to 50 μm. In one embodiment of the present disclosure, the diameters of the twinned grains may be ranged from, for example, 0.1 μm to 45 μm, 0.1 μm to 40 μm, 0.1 μm to 35 μm, 0.5 μm to 35 μm, 0.5 μm to 30 μm, 0.5 μm to 25 μm, 0.5 μm to 20 μm, 0.5 μm to 15 μm, 0.5 μm to 10 μm, 0.5 μm to 5 μm or 0.5 μm to 3 μm; but the present disclosure is not limited thereto. In the present disclosure, the diameters of the twinned grains may be the lengths measured in a direction substantially perpendicular to the twin direction of the twinned grains. More specifically, the diameters of the twinned grains may be the lengths (for example, the maximum length) measured in a direction substantially perpendicular to the lamination direction of the twins or the twin boundaries (i.e., the extension direction of the twin boundary).

In the present disclosure, thicknesses of the plural twinned grains may be respectively ranged from 0.1 μm to 500 μm. In one embodiment of the present disclosure, the thickness of the twinned grains may be ranged from, for example, 0.1 μm to 500 μm, 0.1 μm to 400 μm, 0.1 μm to 300 μm, 0.1 μm to 200 μm, 0.1 μm to 100 μm, 0.1 μm to 80 μm, 0.1 μm to 50 μm, 0.1 μm to 40 μm, 0.1 μm to 35 μm, 0.1 μm to 30 μm, 0.1 μm to 25 μm, 0.1 μm to 20 μm, 0.1 μm to 15 μm, 0.1 μm to 10 μm or 0.1 μm to 5 μm. In the present disclosure, the thicknesses of the twinned grains may be the thicknesses of the twinned grains measured at the twin direction of the twinned grains. More specifically, the thicknesses of the twinned grains may be the thicknesses (for example, maximum thicknesses) of the twinned grains measured at the lamination direction of the twins or the twin boundaries.

In the present disclosure, at least a part of the twinned grains in the nano-twinned copper foil may be formed by plural nano-twins stacking along a direction of [111] crystal axis ±15 degrees. For example, 50% to 99.5%, 50% to 99%, 55% to 99%, 60% to 99%, 65% to 99%, 70% to 99%, 75% to 99%, 75% to 95% or 75% to 90% of the twinned grains may be formed by plural nano-twins stacking along a direction of [111] crystal axis ±15 degrees.

Herein, the lamination direction of the nano-twins (i.e., twin direction) is subject to no particular limitation, an angle may be included between the lamination direction of the nano-twins and the thickness direction of the nano-twinned copper foil, and the angle is subject to no particular limitation. For example, the angle may be ranged from 0 degree to 60 degrees, 0 degree to 55 degrees, 0 degree to 50 degrees, 0 degree to 45 degrees, 0 degree to 40 degrees, 0 degree to 35 degrees, 0 degree to 30 degrees, 0 degree to 25 degrees or 0 degree to 20 degrees. In addition, in the present disclosure, the twinned grains are not necessarily columnar grains parallel to the thickness direction of the nano-twinned copper foil and may be intersected with the thickness direction of the nano-twinned copper foil at the aforementioned angle. Alternatively, the nano-twinned grains may include the grains having different lamination directions at the same time.

In the present disclosure, at least 50% of an area of the surface of the nano-twinned copper foil may expose a (111) surface of the nano-twins, so the surface of the nano-twinned copper foil has a preferred direction of (111). In one embodiment of the present disclosure, the (111) surface of the nano-twins exposed on the surface of the nano-twinned copper foil may be, for example, 50% to 99.5%, 50% to 99%, 55% to 99%, 60% to 99%, 65% to 99%, 70% to 99%, 75% to 99%, 75% to 95% or 75% to 90% of the total area of the surface of the nano-twinned copper foil, but the present disclosure is not limited thereto. Herein, the preferred direction of the surface of the nano-twinned copper foil can be measured by electron backscatter diffraction (EBSD).

In one embodiment of the present disclosure, when the twinned grain has a significant thickness to diameter ratio, for example, when the thicknesses of the twinned grains are significantly greater than the diameters thereof, the twinned grains are columnar grains.

In another embodiment of the present disclosure, at least a part of the twinned grains may be fine grains, and lamination directions of plural nano-twins of the fine grains do not have a preferred direction. More specifically, the twinned grains in the nano-twinned copper foil may not be columnar grains, for example, the twinned grains are fine grains. When the twinned grains are fine grains, the twinned grain do not have a significant thickness to diameter ratio, and the thicknesses and the diameters of the twinned grains are small. For example, the thicknesses and the diameters of the fine grains may be ranged from 100 nm to 500 nm. In addition, the lamination directions of the nano-twins of the fine grains (i.e. the twin directions) are not particularly limited, and the nano-twins exposed on the surface of the nano-twinned copper foil do not have a preferred direction.

In a further embodiment of the present disclosure, the twinned grains comprised in the nano-twinned copper foil may comprise both the columnar grains and the fine grains.

In the present disclosure, whether the twinned grains are the aforesaid columnar grains or the fine grains, at least a part of the twinned grains are connected with each other. For example, at least 50%, 60%, 70%, 80%, 90% or 95% of the twinned grains are connected with each other.

In the present disclosure, “the twin direction of the twinned grain” refers to the lamination direction of the twins or the twin boundaries in the twinned grains. Herein, the twin boundaries of the twinned grains may be substantially perpendicular to the lamination direction of the twins or the twin boundaries.

In the present disclosure, the included angle between the twin direction of the twinned grain and the thickness direction of the nano-twinned copper foil may be measured in a cross-section of the nano-twinned copper foil. Similarly, the features such as the thickness of the nano-twinned copper foil and the diameter or the thickness of the twinned grains may also be measured in a cross-section of the nano-twinned copper foil. Alternatively, the diameter or the thickness of the twinned grains may be measured from the surface of the nano-twinned copper foil. In the present disclosure, the measurement method is not particularly limited, and may be performed with scanning electron microscope (SEM), transmission electron microscope (TEM), focus ion beam (FIB) or other suitable measurement manners.

In the present disclosure, the preparation method of the nano-twinned copper foil is subject to no particular limitation. For example, the nano-twinned copper foil may be prepared by electrodeposition. In one embodiment of the present disclosure, the nano-twinned copper foil may be prepared by the following steps: providing an electrodeposition device, comprising an anode, a cathode, a plating solution and a power supply, wherein the power supply is respectively connected to the cathode and the anode, and the cathode and the anode are immersed into the plating solution; and performing an electrodeposition process with the electrodeposition device to grow the nano-twinned copper foil on a surface of the cathode.

In the present disclosure, the cathode may be used as a substrate. Herein, the cathode may be a substrate with a metal layer formed thereon or a metal substrate. The substrate may be a silicon substrate, a glass substrate, a quartz substrate, a metal substrate, a plastic substrate, a print circuit board, a III-IV group substrate or a lamination substrate thereof Furthermore, the substrate may have a single-layer or multi-layer structure.

In the present disclosure, the plating solution may comprise a copper salt, a hydrochloric acid, and an acid other than hydrochloric acid. Examples of the copper salt comprised in the plating solution may comprise, but are not limited to, copper sulfate, methyl sulfonic copper or a combination thereof Examples of the acid comprised in the plating solution may comprise, but are not limited to, sulfuric acid, methane sulfonic acid or a combination thereof In addition, the plating solution may further comprise an additive, such as gelatin, surfactants, lattice modification agents or a combination thereof

In the present disclosure, the electrodeposition process may be performed with direct current electrodeposition, high-speed pulse electrodeposition, or direct current electrodeposition and high-speed pulse electrodeposition interchangeably. In one embodiment of the present disclosure, the nano-twinned copper foil may be prepared by direct current electrodeposition. The current density used in the direct current electrodeposition may be ranged from, for example, 0.5 ASD to 50 ASD, 1 ASD to 50 ASD, 2 ASD to 50 ASD, 2 ASD to 45 ASD, 3 ASD to 45 ASD, 4 ASD to 45 ASD, 4 ASD to 40 ASD, 4 ASD to 35 ASD or 4 ASD to 30 ASD; but the present disclosure is not limited thereto.

The nano-twinned copper foil provided by the present disclosure may have a single layer or a multi-layered structure. Furthermore, the nano-twinned copper foil provided by the present disclosure may be combined with other material to form a multi-layered composite structure.

The aforesaid electrode comprising the nano-twinned copper foil provided by the present disclosure may be applied onto a lithium-ion battery. Thus, the present disclosure further provides a lithium-ion battery comprising: a lithium counter electrode; the aforesaid electrode; a separator disposed between the lithium counter electrode and the electrode; and an electrolyte disposed between the lithium counter electrode and the electrode and disposed at two sides of the separator.

Other novel features of the disclosure will become more apparent from the following detailed description when taken in conjunction with the accompanying drawings.

### BRIEF DESCRIPTION OF THE DRAWINGS

FIG. 1A is a FIB photo of a nano-twinned copper foil prepared in Embodiment 1 of the present disclosure.

FIG. 1B is an EBSD photo of a nano-twinned copper foil prepared in Embodiment 1 of the present disclosure.

FIG. 2 is a tensile strength curve of a nano-twinned copper foil prepared in Embodiment 1 of the present disclosure.

FIG. 3 is an exploded view of a coin-type half-cell according to Embodiment 2 of the present disclosure.

FIG. 4 is a diagram showing the cycle life of the lithium-ion batteries prepared in Embodiment 2 and Comparative embodiment 1 of the present disclosure.

FIG. 5 is a FIB photo of a nano-twinned copper foil prepared in Embodiment 4 of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

In the present specification, except otherwise specified, the feature A “or” or “and/or” the feature B means the existence of the feature A, the existence of the feature B, or the existence of both the features A and B. The feature A “and” the feature B means the existence of both the features A and B. The term “comprise(s)”, “comprising”, “include(s)”, “including”, “have”, “has” and “having” means “comprise(s)/comprising but is/are/being not limited to”.

Moreover, in the present specification, when an element is described to be arranged “on” another element, it does not essentially means that the elements contact the other element, except otherwise specified. Such interpretation is applied to other cases similar to the case of “on”.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

### Embodiment 1

In the present embodiment, the nano-twinned copper foil was prepared by rotary plating. The equipment for the rotary plating comprises an electroplating tank, a cathode and an anode. The nano-twinned copper foil was formed on the cathode after electroplating. A titanium rotary cylinder electrode as the cathode was assembled below the modulated speed rotator (AFM3M, PINE), the anode was the Ti/IrO₂ dimensionally stable anode (DSA), and a 1 L beaker was used as the electroplating tank. In the present embodiment, the nano-twinned copper foil was prepared by rotary plating, but the present disclosure is not limited thereto.

The plating solution used in the present embodiment was formulated by CuSO₄·5H₂O and de-ionized water. The total amount of 157.23 g of CuSO₄·5H₂O (including 50 g/L of copper ion) was provided, added with additive (provided by Chemleader Corporation) and then 80 g of H₂SO₄ (96%) was added into the plating solution, followed by adding 0.1 ml of hydrochloric acid (12 N). The plating solution was stirred with a stir bar until CuSO₄·5H₂O was dissolved into the solution (0.8 L) well.

In the present embodiment, a programmed power source (E3633A, Keysight) was used for current output, and the electrodeposition was performed with the direct current and pulse electrodeposition. The electrodeposition area was 5×12 cm², the current density was controlled in a range from 4 ASD (A/dm²) to 30 ASD, the electrodeposition temperature was controlled in a range from 6° C. to 50° C., the rotation speed of the modulated speed rotator was 800 rpm, and the electrodeposition was performed at atmospheric pressure.

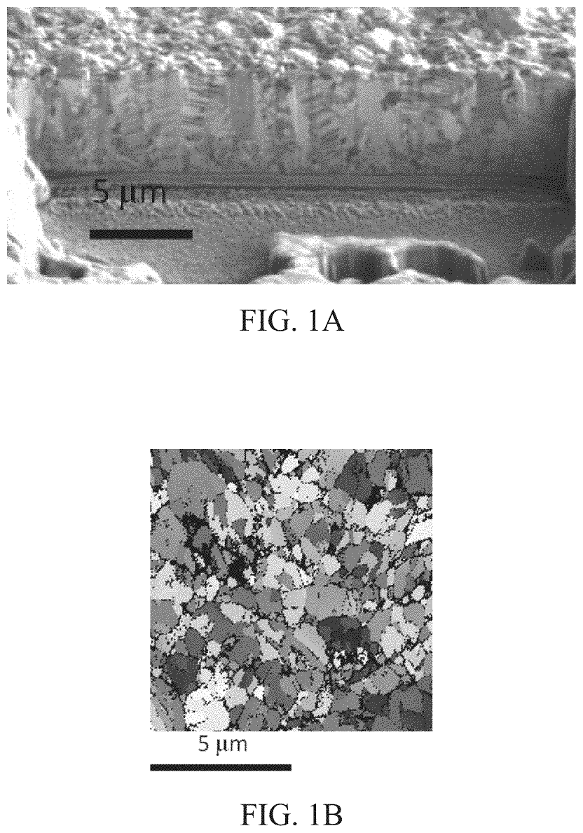

In the present embodiment, the electrodeposition was performed at a current density of 11 ASD and a temperature of 25° C., and the nano-twinned copper foil with a thickness of 5 μm was obtained. The surface preferred direction and the micro-structure of the obtained nano-twinned copper foil was analyzed with electron backscatter diffraction (EBSD) and focus ion beam (FIB). FIG. 1A and FIG. 1B are respectively a FIB photo and an EBSD photo of the nano-twinned copper foil prepared in the present embodiment.

As shown in FIG. 1A, the result obtained by the FIB measurement indicates that most of the grains in the nano-twinned copper foil are formed by twins with high density. 60% or more in volume of the nano-twinned copper foil comprises twinned grains. The included angles between the twin direction of 40% or more of the twinned grains and the thickness direction of the nano-twinned copper foil are ranged from about 0 degree to 30 degrees. The included angles between the twin direction of 40% or more of the twinned grains and the surface of the substrate are range from about 60 degrees to 90 degrees. In addition, 80% or more of the twinned grains in the nano-twinned copper foil have the thickness ranging from about 0.1 μm to about 5 μm.

Furthermore, as shown in FIG. 1B, the result obtained by the EBSD measurement indicates that the diameters of the twinned grains measured on the surface of the nano-twinned copper foil of the present embodiment are ranged from about 0.5 μm to 3 μm. In addition, about 50% of the twinned grains measured on the surface of the nano-twinned copper foil are formed by stacking nano-twins along a [111] crystal axis (±15 degrees), and this indicates that the nano-twinned copper foil of the present embodiment has a (111) preferred direction.

A tensile test was performed on the nano-twinned copper foil of the present embodiment. Before the tensile test, the nano-twinned copper foil was cut into a bone-shape by the punch machine to form the standard specimen for the tensile test. Herein, a tensile tester for measuring the characteristics of the metal sheet (AGS-X 10 N˜10 kN, SHIMADZU) was used to perform the tensile test. The strain rate during the stretching at room temperature was controlled at 4.17×10⁻³ s⁻¹. The original tensile data was recorded by the load unit, Newton (N), and was converted into the stress unit, megapascals (MPa) in consideration of the thickness and the width of the test specimen.

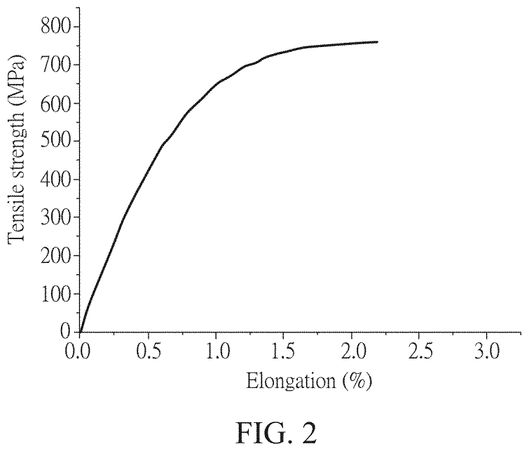

FIG. 2 is a tensile strength curve of the nano-twinned copper foil prepared in the present embodiment. The result shown in FIG. 2 indicates that the tensile strength of the nano-twinned copper foil (5 μm) prepared in the present embodiment can be as high as 800 MPa. This result indicates that the nano-twinned copper foil prepared in the present embodiment has high strength. In addition, when the nano-twinned copper foil of the present embodiment was annealed at 100° C. for 1 hour, the tensile strength of the annealed nano-twinned copper foil was almost unchanged. This result indicates that the nano-twinned copper foil prepared in the present embodiment has high thermal stability.

In other embodiments of the present disclosure, the nano-twinned copper foils with different tensile strength (ranging from 400 MPa to 850 MPa) can be prepared by adjusting the current density (ranging from 4 ASD to 30 ASD) and the temperature (ranging from 6° C. to 50° C.) during the electrodeposition.

### Embodiment 2

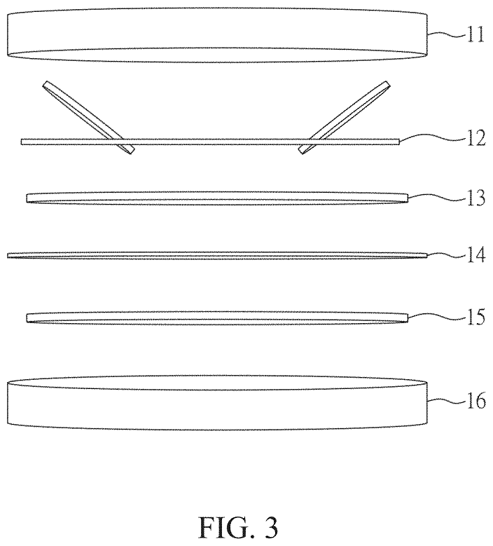

FIG. 3 is an exploded view of a coin-type half-cell of the present embodiment. The coin-type half-cell comprises: an upper case 11, a battery gasket and spring 12, a negative electrode 13, a separator 14, a lithium counter electrode 15 and a bottom case 16. In the present embodiment, the nano-twinned copper foil (5 μm) prepared in Embodiment 1 was used as the collector, and then a negative electrode material was applied onto the collector, followed by punching into the circular shape to obtain the negative electrode 13 of the lithium-ion battery. Then, the negative electrode 13 was assembled with other components to form the coin-type half-cell of the present embodiment.

In the present embodiment, the active material comprised in the negative electrode material was a mixture of silicon (crystallized Si) and silicon nitride, wherein the content of the silicon nitride was about 50% based on the total weight of the silicon and the silicon nitride. In other embodiments of the present disclosure, the content of the silicon nitride may be ranged from 25% to 85% based on the total weight of the silicon and the silicon nitride. In addition, the negative electrode material may further comprise a conductive agent and an adhesive agent. In the present embodiment, the conductive agent was super P, the adhesive agent was sodium poly-acrylate (Na-PAA), and a weight ratio of the active material, the conductive agent and the adhesive agent was 70:20:10 (wt %).

Furthermore, in the present embodiment, the used separator 14 was a polypropylene/polyethylene multi-layer separator. The electrolyte comprised 1 M of LiPF₆ (in ethylene carbonate/diethyl carbonate (EC/DEC) with a volume ratio of 1:1) and 5 wt % of fluoroethylene carbonate (FEC). The lithium counter electrode 15 was a lithium foil.

### Comparative Embodiment 1

The coin-type half-cell of the present comparative embodiment is similar to that shown in Embodiment 2, except that the collector used herein was a rolled copper foil.

The coin-type half-cells prepared in Embodiment 2 and Comparative embodiment 1 were tested by the charge and discharge test to understand the influence of the nano-twinned copper foil on the efficiency of the lithium-ion battery. Herein, the charge and discharge test was performed with different currents of 0.5, 1, 2, 3 and 5 A/g, and the voltage range was 0.01-1.2 V. The results are shown in the following Table 1.

TABLE 1

| | | | | Comparative | |
|---|---|---|---|---|---|
| | Embodiment 2 | | | embodiment 1 | |
| | Delithiation | Lithiation | | Delithiation | Lithiation |
| Current rate | capacity | capacity | Current rate | capacity | capacity |
| (A/g) | (mAh/g) | (mAh/g) | (A/g) | (mAh/g) | (mAh/g) |
| 0.2 | 1488.8 | 1543.1 | 0.2 | 1219.9 | 1260.0 |
| 0.5 | 1396.9 | 1423.7 | 0.5 | 1132.6 | 1152.6 |
| 1 | 1267.6 | 1283.2 | 1 | 953.3 | 963.6 |
| 2 | 1058.8 | 1068.1 | 2 | 782.9 | 789.2 |
| 3 | 927.3 | 933.8 | 3 | 666.3 | 670.9 |
| 5 | 757.3 | 761.6 | 5 | 488.4 | 491.3 |

| | | | |
|---|---|---|---|
| High rate | 50.9% | High rate | 40.0% |
| retention | | retention | |
| (0.2 A/g current | | (0.2 A/g current | |
| rate/5 A/g | | rate/5 A/g | |
| current rate) | | current rate) | |

As shown in Table 1, the coin-type half-cell using the nano-twinned copper foil as the collector prepared in Embodiment 2 has slightly increased delithiation capacity (the capacity that the lithium ions release from the negative active material during discharging) and lithiation capacity (the capacity that the negative active material uptakes the lithium ions during charging) at low current rate (0.2 A/g). As the current rate was increased to 5 A/g, the delithiation capacity and the lithiation capacity of the coin-type half-cell using the nano-twinned copper foil prepared in Embodiment 2 was about 150% of that of the coin-type half-cell using the rolled copper foil prepared in Comparative embodiment 1.

In addition, after calculating the high rate retention of the coin-type half-cells of Embodiment 2 and Comparative embodiment 1, the high rate retention of the coin-type half-cell using the nano-twinned copper foil prepared in Embodiment 2 was about 50.9%, which is better than the high rate retention of 40.0% of the coin-type half-cell using the rolled copper foil prepared in Comparative embodiment 1. Thus, using the nano-twinned copper foil as the collector of the negative electrode can effectively improve the efficiency of the lithium-ion battery.

### Embodiment 3

The coin-type half-cell of the present embodiment is similar to that shown in Embodiment 2, except that the silicon and silicon nitride comprised in the negative electrode material of Embodiment 2 was replaced by graphite in the present embodiment.

The coin-type half-cells prepared in Embodiment 2 and Embodiment 3 were tested by the aforesaid charge and discharge test, to understand the influence of different negative electrode materials on the efficiency of the lithium-ion battery. Herein, 1 C was 0.372 A/g, and the results are shown in the following Table 2.

TABLE 2

| | | Embodiment 3 | | | Embodiment 2 | |
|---|---|---|---|---|---|---|
| | | Delithiation | Lithiation | | Delithiation | Lithiation |
| | | capacity | capacity | Current rate | capacity | capacity |
| C rate | | (mAh/g) | (mAh/g) | (A/g) | (mAh/g) | (mAh/g) |
| 0.2 | C | 348.9 | 351.4 | 0.2 | 1488.8 | 1543.1 |
| 0.5 | C | 331.2 | 332.5 | 0.5 | 1396.9 | 1423.7 |
| 1 | C | 275.2 | 275.8 | 1 | 1267.6 | 1283.2 |
| 2 | C | 207.2 | 207.5 | 2 | 1058.8 | 1068.1 |
| 3 | C | 146.2 | 146.4 | 3 | 927.3 | 933.8 |
| 5 | C | 90.4 | 90.5 | 5 | 757.3 | 761.6 |

| | | | |
|---|---|---|---|
| High rate | 25.9% | High rate | 50.9% |
| retention | | retention | |
| (5/0.2) | | (5/0.2) | |

As shown in Table 2, at low current rate, the delithiation capacity (the capacity that the lithium ions release from the negative active material during discharging) and lithiation capacity (the capacity that the negative active material uptakes the lithium ions during charging) of the coin-type half-cell using Si/Si₃N₄ prepared in Embodiment 2 was about 400% of that of the coin-type half-cell using graphite prepared in Embodiment 3. As the C-rate was increased to 5 C (i.e. 1.86 A/g), the delithiation capacity and the lithiation capacity of the coin-type half-cell using Si/Si₃N₄ prepared in Embodiment 2 was about 800% or more of that of the coin-type half-cell using graphite prepared in Embodiment 3. These results indicate that when the nano-twinned copper foil (5 μm) was used as the collector of the lithium-ion battery, the battery using Si/Si₃N₄ as the active material has better performance than the battery using graphite as the active material.

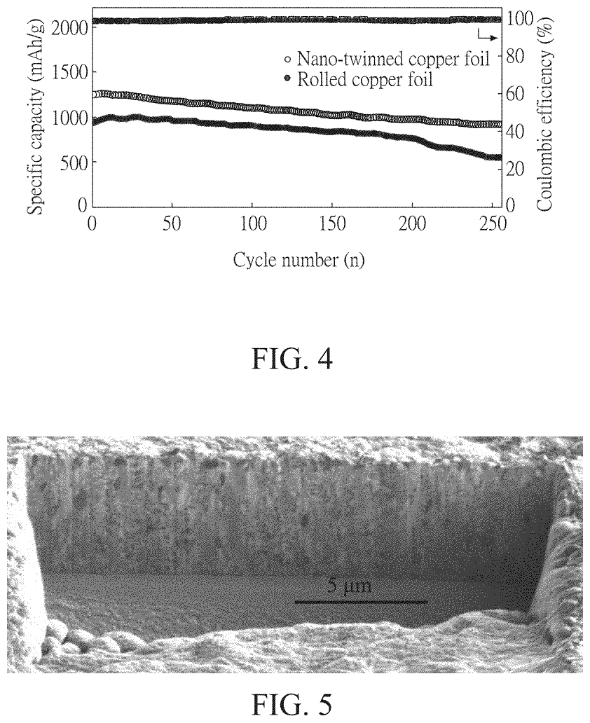

FIG. 4 is a diagram showing the cycle life of the lithium-ion batteries prepared in Embodiment 2 and Comparative embodiment 1 of the present disclosure. As shown in FIG. 4, the cycle life of the lithium-ion battery using the nano-twinned copper foil is better than that of the lithium-ion battery using the rolled copper foil. After 250 cycles, the capacity retention rates of the lithium ion batteries using the nano-twinned copper foil and the rolled copper foil are respectively 73% and 59% after cycling charging and discharging.

### Embodiment 4

The nano-twinned copper foil of the present embodiment was prepared by the similar process illustrated in Embodiment 1, except for the following differences.

The plating solution used in the present embodiment comprises CuSO₄.5H₂O (including 50 g/L of copper ion), 100 g of H₂SO₄, HCl (including 50 ppm of chloride ion), and additive (9 ml/L). The rotation speed was 1200 rpm and the current density was 15 ASD. The obtained nano-twinned copper foil has a thickness of 5 μm.

FIG. 5 is a FIB photo of a nano-twinned copper foil prepared in the present embodiment. As shown in FIG. 5, the nano-twinned copper foil was formed by fine twinned grains without specific directions, and the diameters of the fine twinned grains (i.e. the grain size) were ranged from about 100 nm to about 500 nm.

The coin-type half-cell of the present embodiment is similar to that shown in Embodiment 2, except that the collector used herein was the 5 μm of the nano-twinned copper foil prepared in the present embodiment, and the active material comprised in the negative electrode material is silicon (crystallized Si) but does not comprise silicon nitride.

### Comparative Embodiment 2

The coin-type half-cell of the present comparative embodiment is similar to that shown in Embodiment 4, except that the collector used herein was a rolled copper foil.

The coin-type half-cells prepared in Embodiment 4 and Comparative embodiment 2 were tested by the aforesaid charge and discharge test, to understand the influence of the nano-twinned copper foil on the efficiency of the lithium-ion battery. The results are shown in the following Table 3.

TABLE 3

| | | | | Comparative | |
|---|---|---|---|---|---|
| | Embodiment 4 | | | embodiment 2 | |
| | Delithiation | Lithiation | | Delithiation | Lithiation |
| Current rate | capacity | capacity | Current rate | capacity | capacity |
| (A/g) | (mAh/g) | (mAh/g) | (A/g) | (mAh/g) | (mAh/g) |
| 0.2 | 2574.9 | 2638.9 | 0.2 | 2385.0 | 2448.6 |
| 0.5 | 2280.4 | 2334.6 | 0.5 | 1899.3 | 1953.0 |
| 1 | 1864.9 | 1896.9 | 1 | 1430.1 | 1447.4 |
| 2 | 1457.7 | 1471.8 | 2 | 945.4 | 946.1 |
| 3 | 1153.8 | 1159.1 | 3 | 543.6 | 544.7 |
| 5 | 773.6 | 771.8 | 5 | 394.5 | 395.5 |

| | | | |
|---|---|---|---|
| High rate | 29.2% | High rate | 16.2% |
| retention | | retention | |
| (0.2 A/g current | | (0.2 A/g current | |
| rate/5 A/g | | rate/5 A/g | |
| current rate) | | current rate) | |

As shown in Table 3, the coin-type half-cell using the nano-twinned copper foil as the collector prepared in Embodiment 4 has slightly increased delithiation capacity (the capacity that the lithium ions release from the negative active material during discharging) and lithiation capacity (the capacity that the negative active material uptakes the lithium ions during charging) at low current rate (0.2 A/g). As the current rate was increased to 5 A/g, the delithiation capacity and the lithiation capacity of the coin-type half-cell using the nano-twinned copper foil prepared in Embodiment 4 was about 196% of that of the coin-type half-cell using the rolled copper foil prepared in Comparative embodiment 2.

In addition, after calculating the high rate retention of the coin-type half-cells of Embodiment 4 and Comparative embodiment 2, the high rate retention of the coin-type half-cell using the nano-twinned copper foil prepared in Embodiment 4 was about 29.2%, which is better than the high rate retention of 16.2% of the coin-type half-cell using the rolled copper foil prepared in Comparative embodiment 2. Thus, using the nano-twinned copper foil as the collector of the negative electrode can effectively improve the efficiency of the lithium-ion battery.

In conclusion, compared to the lithium-ion battery using the rolled copper foil as the collector of the negative electrode, the charge and discharge characteristics and the cycle life of the lithium-ion battery using the nano-twinned copper foil as the collector of the negative electrode can be effective improved. In addition, when the nano-twinned copper foil is used in combination with the silicon-based negative electrode material, the charge and discharge characteristics of the lithium-ion battery can further be improved. In particular, the nano-twinned copper foil of the present disclosure has high strength, and can be resistant to the volume change of the silicon-based negative material during charging and discharging. Therefore, the stability and reliability of the lithium-ion battery can further be improved.

Although the present disclosure has been explained in relation to its embodiment, it is to be understood that many other possible modifications and variations can be made without departing from the spirit and scope of the disclosure as hereinafter claimed.

What is claimed is:

1. An electrode for a lithium-ion battery, comprising:
a collector comprising a nano-twinned copper foil; and
a negative electrode material disposed on the collector, wherein the negative electrode material comprises an active material comprising at least one selected from the group consisting of: silicon, silicon nitride, graphite, graphene, carbon nanotubes, carbon nano-fibers and carbon nano-particles.

2. The electrode of claim 1, wherein the active material comprises silicon and silicon nitride.

3. The electrode of claim 2, wherein a content of the silicon nitride is ranged from 25% to 85% based on a total weight of the silicon and the silicon nitride.

4. The electrode of claim 1, wherein a thickness of the nano-twinned copper foil is ranged from 1 μm to 500 μm.

5. The electrode of claim 1, wherein at least 50% in volume of the nano-twinned copper foil comprises plural twinned grains.

6. The electrode of claim 5, wherein diameters of the plural twinned grains are respectively ranged from 0.1 μm to 50 μm.

7. The electrode of claim 5, wherein thicknesses of the plural twinned grains are respectively ranged from 0.1 μm to 500 μm.

8. The electrode of claim 5, wherein at least a part of the plural twinned grains are connected with each other.

9. The electrode of claim 5, wherein at least a part of the plural twinned grains are fine grains, and lamination directions of plural nano-twins of the fine grains do not have a preferred direction.

10. The electrode of claim 5, wherein at least a part of the plural twinned grains are formed by plural nano-twins stacking along a [111] crystal axis.

11. The electrode of claim 10, wherein an included angle between a lamination direction of the at least a part of the plural twinned grains and a thickness direction of the nano-twinned copper foil is ranged from 0 degree to 60 degrees.

12. The electrode of claim 1, wherein at least 50% of an area of a surface of the nano-twinned copper foil expose (111) surfaces of plural nano-twins.

13. A lithium-ion battery, comprising:
a lithium counter electrode;
an electrode, comprising:
a collector comprising a nano-twinned copper foil; and
a negative electrode material disposed on the collector, wherein the negative electrode material comprises an active material comprising at least one selected from the group consisting of: silicon, silicon nitride, graphite, graphene, carbon nanotubes, carbon nano-fibers and carbon nano-particles;
a separator disposed between the lithium counter electrode and the electrode; and
an electrolyte disposed between the lithium counter electrode and the electrode and disposed at two sides of the separator.

14. The lithium-ion battery of claim 13, wherein the active material comprises silicon and silicon nitride.

15. The lithium-ion battery of claim 14, wherein a content of the silicon nitride is ranged from 25% to 85% based on a total weight of the silicon and the silicon nitride.

16. The lithium-ion battery of claim 13, wherein a thickness of the nano-twinned copper foil is ranged from 1 μm to 500 μm.

17. The lithium-ion battery of claim 13, wherein at least 50% in volume of the nano-twinned copper foil comprises plural twinned grains.

18. The lithium-ion battery of claim 17, wherein at least a part of the plural twinned grains are fine grains, and lamination directions of plural nano-twins of the fine grains do not have a preferred direction.

19. The lithium-ion battery of claim 17, wherein at least a part of the plural twinned grains are formed by plural nano-twins stacking along a [111] crystal axis.

20. The lithium-ion battery of claim 13, wherein at least 50% of an area of a surface of the nano-twinned copper foil expose (111) surfaces of plural nano-twins.
